(19) United States
(12) Patent Application Publication
(10) Pub. No.: US 2024/0364696 A1
(43) Pub. Date: Oct. 31, 2024

(54) ACCESS POLICY GENERATION FOR AUTHORIZATION PLUGINS

(71) Applicant: International Business Machines Corporation, Armonk, NY (US)

(72) Inventors: YAN HUANG, BEIJING (CN); Zheng Lei An, BEIJING (CN); Lei Wang, BEIJING (CN); Shuang Shuang Jia, BEIJING (CN); Heng Wang, BEIJING (CN); Xiao Ling Chen, Beijing (CN); Wen Ya Zhou, BEIJING (CN); Qing Yu Pei, Beijing (CN)

(21) Appl. No.: 18/141,384

(22) Filed: Apr. 29, 2023

(51) Int. Cl. H04L 9/40

(52) U.S. Cl. CPC H04L 63/105; H04L 63/104; H04L 63/20

(57) ABSTRACT

An example operation may include one or more of storing access requirements of a containerized environment, identifying a plurality of types of users of the containerized environment based on the access requirements, identifying a plurality of different restriction priorities for the plurality of types of users within the containerized environment, respectively, based on the access requirements, dynamically generating an access policy that satisfies the plurality of different restriction priorities for the plurality of types of users within the containerized environment, and transforming the access policy into a plugin.

### BACKGROUND

An authorization plugin is a software process that approves or denies requests to a daemon such as a container daemon. A container can provide a ready-to-work authorization plugin that can use an engine to contact the daemon and run client commands.

### SUMMARY

One example embodiment provides an apparatus that may include a storage configured to store access requirements of a containerized environment, and a processor that may be configured to perform one or more of identify a plurality of types of users of the containerized environment based on the access requirements, identify a plurality of different restriction priorities for the plurality of types of users within the containerized environment, respectively, based on the access requirements, dynamically generate an access policy that satisfies the plurality of different restriction priorities for the plurality of types of users within the containerized environment, and transform the access policy into a plugin.

Another example embodiment provides a method that includes one or more of storing access requirements of a containerized environment, identifying a plurality of types of users of the containerized environment based on the access requirements, identifying a plurality of different restriction priorities for the plurality of types of users within the containerized environment, respectively, based on the access requirements, dynamically generating an access policy that satisfies the plurality of different restriction priorities for the plurality of types of users within the containerized environment, and transforming the access policy into a plugin.

A further example embodiment provides a computer-readable medium comprising instructions, that when read by a processor, cause the processor to perform one or more of storing access requirements of a containerized environment, identifying a plurality of types of users of the containerized environment based on the access requirements, identifying a plurality of different restriction priorities for the plurality of types of users within the containerized environment, respectively, based on the access requirements, dynamically generating an access policy that satisfies the plurality of different restriction priorities for the plurality of types of users within the containerized environment, and transforming the access policy into a plugin.

### BRIEF DESCRIPTION OF THE DRAWINGS

FIG. 1 depicts a computing an environment, according to example embodiments.

FIG. 2A is a diagram illustrating a system for generating an access policy for an authorization plugin, according to example embodiments.

FIGS. 2B-2C are diagrams illustrating a process of generating and transforming an access policy into an authorization plugin, according to example embodiments.

FIG. 2D is a diagram illustrating a graph model for generating access policies, according to example embodiments.

FIG. 2E is a diagram illustrating a list of restrictions that can be used to generate the access policy, according to example embodiments.

FIG. 3A is a diagram illustrating a method of generating an access policy for an authorization plugin, according to example embodiments.

FIG. 3B is a diagram illustrating a method of generating an access policy for an authorization plugin, according to other example embodiments.

### DETAILED DESCRIPTION

It is to be understood that although this disclosure includes a detailed description of cloud computing, implementation of the teachings recited herein is not limited to a cloud computing environment. Rather, embodiments of the instant solution are capable of being implemented in conjunction with any other type of computing environment now known or later developed.

DOCKER® provides a ready-made authorization plugin which controls access to a containerized environment. The plugin is limited. Therefore, if a customer's runtime environment requires greater access control, the customer can create additional authorization plugins for managing access and add them to a daemon configuration. Regardless of whether the customer uses the ready-made plugin or a custom-designed plugin, the customer must define granular access policies in advance. But it is always difficult and complex to create an effective and full access policy when considering the different user groups, restrictions, permissions, resources, and the like. Currently this relies on the personal experiences of a plugin developer and/or a DOCKER® administrator. However, defining an access policy “manually” is a complicated and error-prone process that is further complicated with larger runtime environments and user types.

The example embodiments are directed to a system and method which can automatically generate an access policy that adheres to or otherwise satisfies different access restrictions for different user groups among a shared containerized runtime environment. The access policy can be transformed into an authorization plugin that can be deployed in a DOCKER® runtime environment based on predefined restriction priorities, restriction levels and the like. The system can collect information about users, user groups, user roles, resources that need to restrict access in the runtime environment from the host or the user interaction, and the like. The system may generate “tactics” or policies and rules which match the access restrictions of the policy including the different access restrictions for the different user groups. Furthermore, the system may transform the access policy in text format to a plugin syntax format that can be added to an authorization plugin of the runtime environment.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing

capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure, including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure, including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community with shared concerns (e.g., mission, security requirements, policy, and compliance considerations). It may be managed by organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service-oriented with a focus on statelessness, low coupling, modularity, and semantic interoperability. At the heart of cloud computing is an infrastructure that includes a network of interconnected nodes.

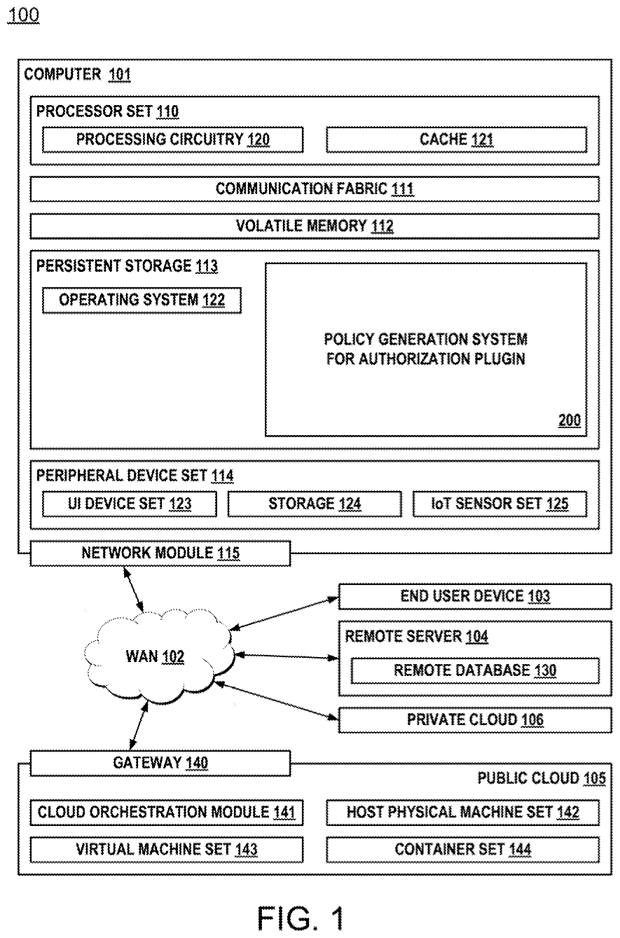

Referring now to FIG. 1, a computing environment 100 is depicted. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again, depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

Computing environment 100 contains an example of an environment for executing at least some of the computer code involved in performing the inventive methods, such as 200. In addition to block 200, computing environment 100 includes, for example, computer 101, wide area network (WAN) 102, end-user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smartphone, smartwatch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, the performance of a computer-implemented method may be distributed among multiple computers and/or between multiple locations. On the other hand, in this presentation of the computing environment 100, a detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is a memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off-chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric comprises switches and electrically conductive paths, such as the switches and electrically conductive paths that make up buses, bridges, physical input/output ports, and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read-only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smartwatches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, this data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanations of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as communicating with WAN 102, in other embodiments, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both parts of a larger hybrid cloud.

A container can provide a ready-to-work plugin that can use an engine to contact a daemon and run client commands. Many users, however, require different or greater access control policies than the default access control policies of the ready-to-work plugin. The drawback for such users that require greater access control is an availability of a plugin that satisfies all of the requirements and restrictions of the user.

An example of a container is DOCKER®, which relies on a client-server architecture for communication with a daemon which can build, run, and distribute containers. In this environment, the client and the daemon can run on the same system or the client can connect to a remote daemon. The client and the daemon may communicate using a representational state transfer (REST) application programming interface (API) over UNIX sockets, a network interface, ports, or the like. In the following examples, a DOCKER® daemon uses a novel policy generator for generating an access policy for a DOCKER® environment of a front-end tenant or organization. The policy generator can ingest data from within the DOCKER® environment, identify different user groups and the different access restrictions associated with the different user groups, and build a policy based on the restrictions. The policy can be integrated into a plugin such as an authorization plugin that is deployed or can be deployed within the DOCKER® environment.

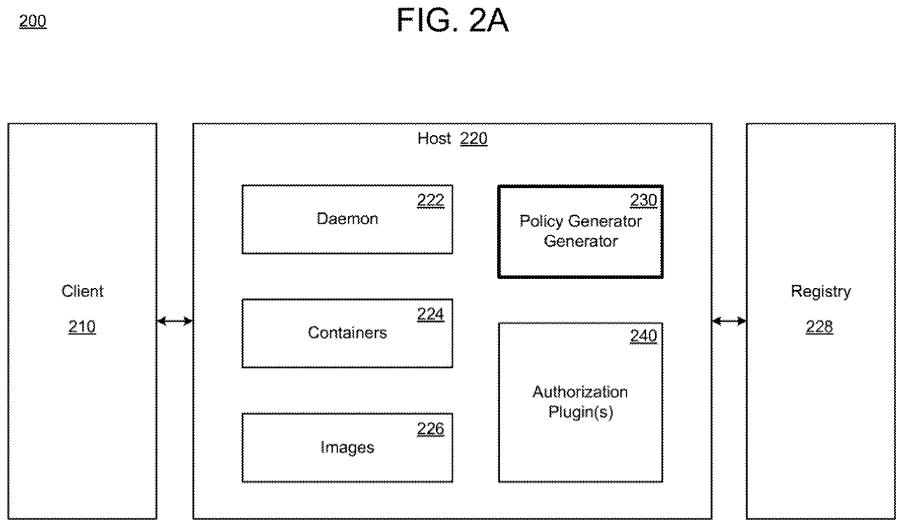

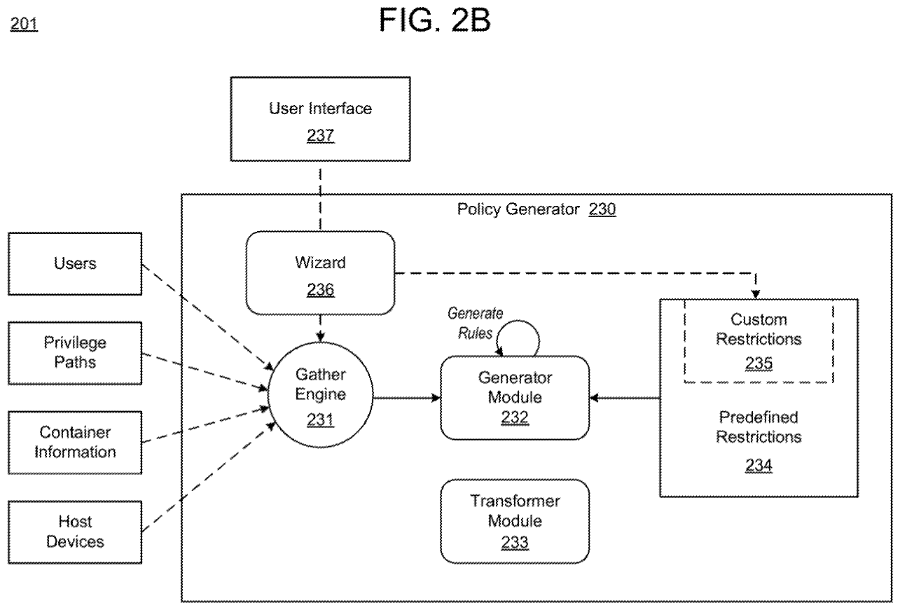

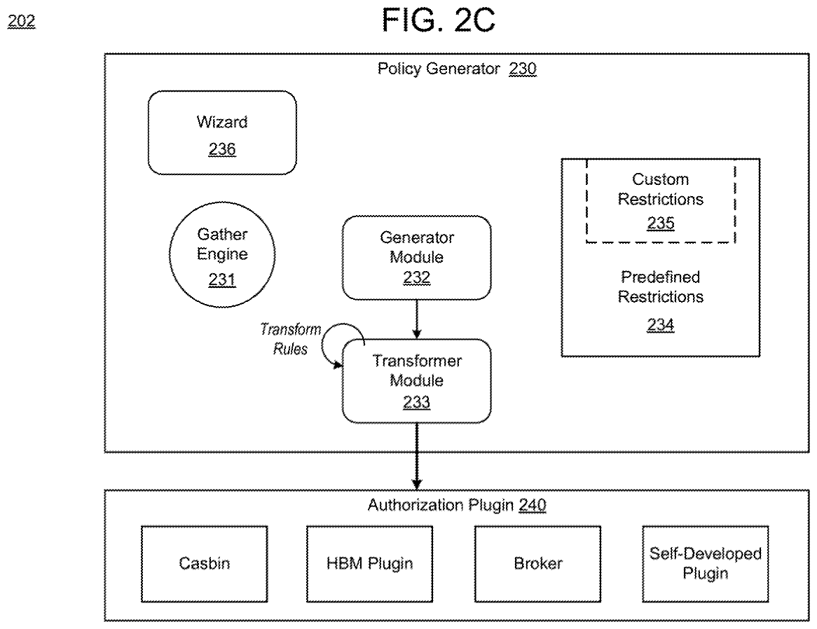

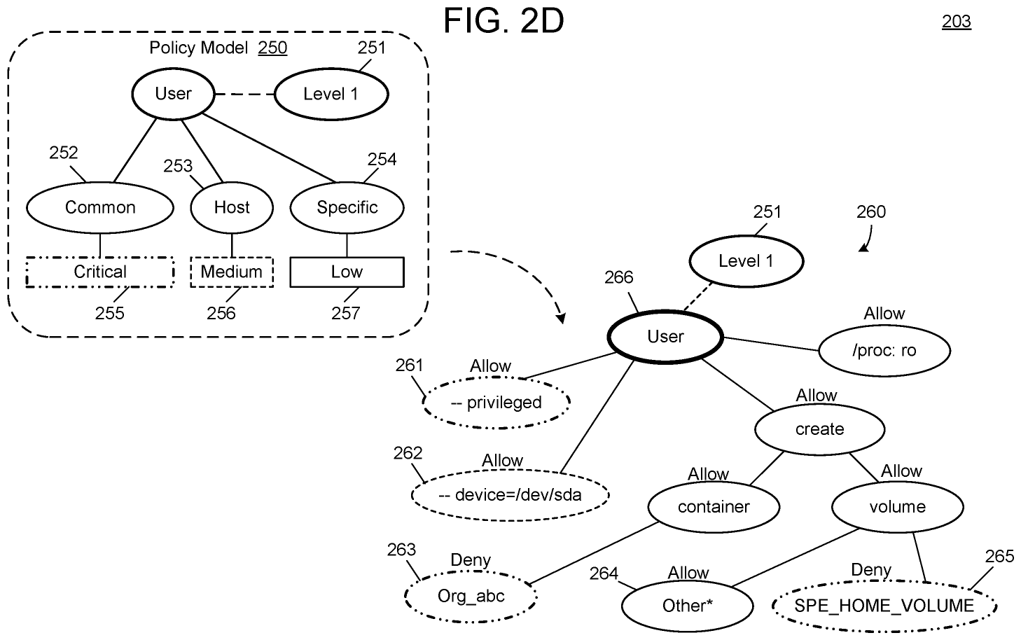

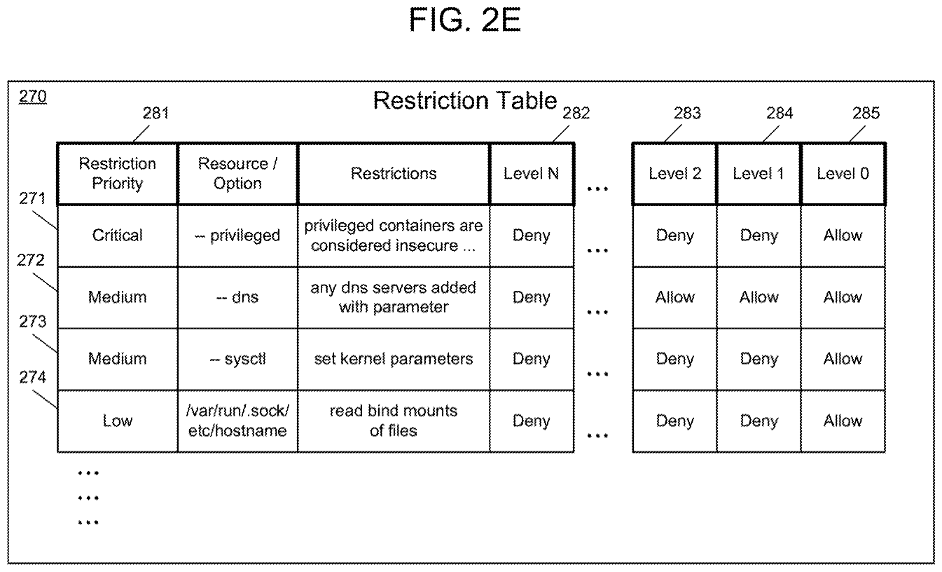

FIG. 2A illustrates a policy generation system 200 for generating an access policy for an authorization plugin according to example embodiments. Referring to FIG. 2A, the policy generation system 200 includes a host 220 which hosts a runtime environment for containerized applications and programs. A daemon 222 may manage the image build and deployment of container images 226 based on instructions received from a client 210. The container images 226 may be used to instantiate or launch containers 224. In some embodiments, the container images 226 may be held within a registry 228. The host 220 may also provide access management to resources of the runtime environment including namespaces, network paths, hosts, and the like. The access may be based on access policies that are stored in one or more authorization plugins 240.

According to various embodiments, the host 220 also includes a policy generator 230 which is further described in FIG. 2B. The policy generator 230 is configured to identify user groups within the runtime environment of the host 220 and access restrictions that are assigned to the user groups. Each user group may have a different set of access restrictions with respect to the resources within the runtime environment. However, it should also be appreciated that the user groups may have the same set of access restrictions, partially overlapping sets of access restrictions (where some of the restrictions are common among each and some are different), and the like.

FIGS. 2B-2C illustrate a process of generating and transforming an access policy into an authorization plugin according to example embodiments. For example, FIG. 2B illustrates a process 201 of generating an access policy for a runtime environment (such as a DOCKER® runtime environment) based on restriction levels, user groups, restriction priorities, and the like, of the environment which can be obtained from the users, the paths of the network, container images, container metadata, host devices, and the like. This information may be collected by a gather engine 231 of the policy generator 230. For example, the gather engine 231 may collect the information from user devices, privilege paths, container information, host devices, a DOCKER® Admin/Plugin Developer, and the like. The gather engine 231 can be located in the host 220 as depicted or in the client 210.

The policy generator 230 may also include a generator module 232 which may generate the access policy to meet the runtime environment's requirements based on the restrictions' definitions and levels. The restrictions may include predefined restrictions 234 and/or custom restrictions 235 held within a storage of the environment such as the registry 228 or the like. The restrictions may be stored in tabular format such as shown in the example of FIG. 2E.

Referring again to FIG. 2B, the policy generator 230 may also include a wizard 236 output via a user interface 237 where developers or the like can create new “custom” restrictions, new user groups, new resources, and the like, or modify existing restrictions, users, resources, etc. The wizard 236 is a function that can guide a user to collect customized information of users/user groups/user roles and various resources to restrict access to the daemon.

FIG. 2C illustrates a process 202 transforming an access policy generated by the policy generator 230 into code that can be executed within a plugin. In this example, the policy generator 230 includes a transformer module 233 configured to transform policy rules into a format which can be added to authorization plugins and executed therewith. In this example, the transformer module 233 may transfer the converted policy information into existing or custom-designed access authorization plugins.

According to various embodiments, the policy generator 230 may identify command line interface (CLI) commands that are available within the runtime environment for the organization. The policy generator 230 may also identify restrictions on the available CLI commands. The restrictions may be different for different user groups. These restrictions on CLI commands within an environment, such as the DOCKER® environment, can be used to create or generate access policies in an automated manner.

FIG. 2D illustrates a process 203 of generating an access policy 260 for a particular user type 251 based on a policy graph model 250 (also referred to herein as a tactics generating model) for generating access policies for user groups/types according to example embodiments. The graph model 250 may be embedded within the policy generator 230 or it may be accessed from a storage by the policy generator 230 and used to generate an access policy 260. Referring to FIG. 2D, the graph model 250 includes a user type value 251, types of resources 252, 253, and 254, (i.e., common, host, and specific), and types of restrictions 255, 256, and 257 (i.e., critical, medium, and low) on the types of resources 252, 253, and 254, respectively. It should be appreciated that this model is an example of the resources, the user types/roles, the types of restrictions, and the like, which may be incorporated into an access policy generating model. Other models, with different resources, user types/roles and types of restrictions, can be incorporated into the access policy generating model.

In this example, there are three kinds of nodes in the graph model 250 including a user node 251, a restriction level node (e.g., 252, 253, and 254) identifying different resource types, and restriction set nodes 255, 256, and 257, which define restrictions on the different resources within the restriction level nodes 252, 253, and 254. The edges represent the restriction priorities and restriction level of restrictions are defined for the user.

Using the graph model 250, the host system may generate the access policy 260 for a user 266 of the user type 251. There may be different models for different user types. But in this case, the user is of the same user type 251 as the model 250. During this process, the host process may perform the following steps to fill in the nodes 261, 262, 263, 264, and 265 of the access policy 260. For example, when generating the access policy 260, the host system may generate allow/deny polices based on existing policies used for plugins. The policies may include common policies and special policies. Default restrictions (e.g., common policies) of command line interface options (for example, DOCKER® command line interface options) may exist as unauthorized access by containers to an underlying host (such as a Linux host) could occur. Special restrictions (e.g., special policies) of the containers and images which depend on different environments (such as DOCKER® environments) may also be present.

The system described herein may generate the common policies based on the known allow/deny policy, privileged containers or containers that require direct access to the resources of the Linux host. The host system may generate an initial policy based on inputs. For example, a special container and image related information may be generated based on user inputs. In addition, the host system may generate test cases for testing restricted commands based on the initial policy. The test cases may be executed within the DOCKER® environment, for example, via a command line interface.

Based on the results of the execution of the test cases, additional access restrictions may be identified. These are special cases or custom cases. In response, the host process may extract a special requirement by running existing test cases, for example, the special container and image related information such as container/image identifier. Furthermore, the host process may customize different capabilities to create commands sets for the different user groups, create special policies, and if the available plugins are used, the policies generated can be transformed to the polices used in these plugins. If not, a new custom plugin can be generated.

FIG. 2E illustrates a table 270 with a list of restrictions that can be used to generate an access policy according to example embodiments. For example, the policy generator 230 may access the table 270 from storage/the registry 228 and use it to generate an access policy. According to various embodiments, new attributes are added to the restriction table 270 including a restriction priority value 281 and restriction levels 282, 283, 284, 285, etc. The restriction priority values 281 are introduced to identify the priorities of predefined restriction sets. Furthermore, the restriction levels 282 are introduced to define deny/access to the restriction objects (resources) of an environment, such as the DOCKER® environment.

Within the table 271, different restrictions 271, 272, 273, and 274 on different resources are provided. For example, the restrictions may be applied to shared resources such as files, file paths, network locations within the environment, hosts, namespaces, and the like.

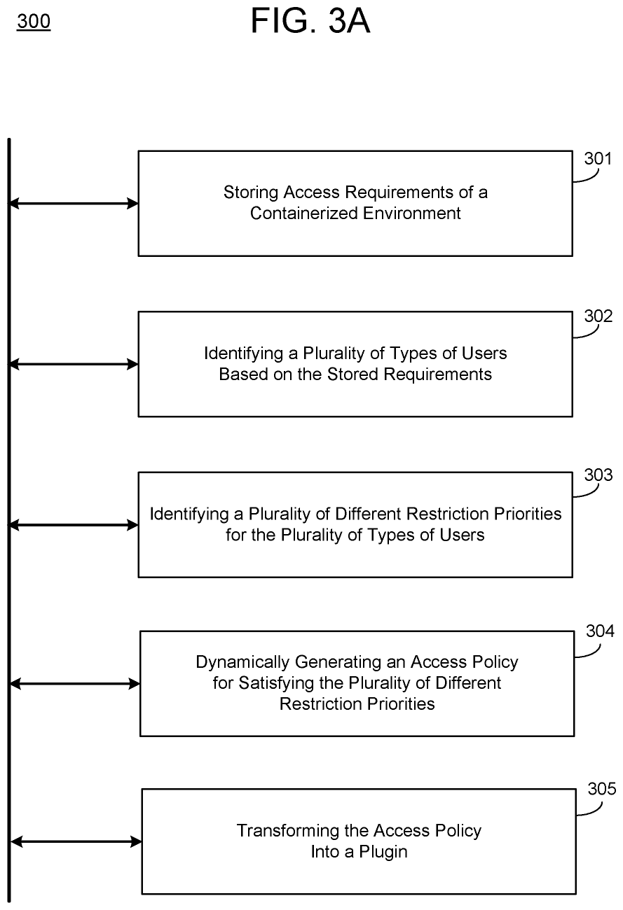

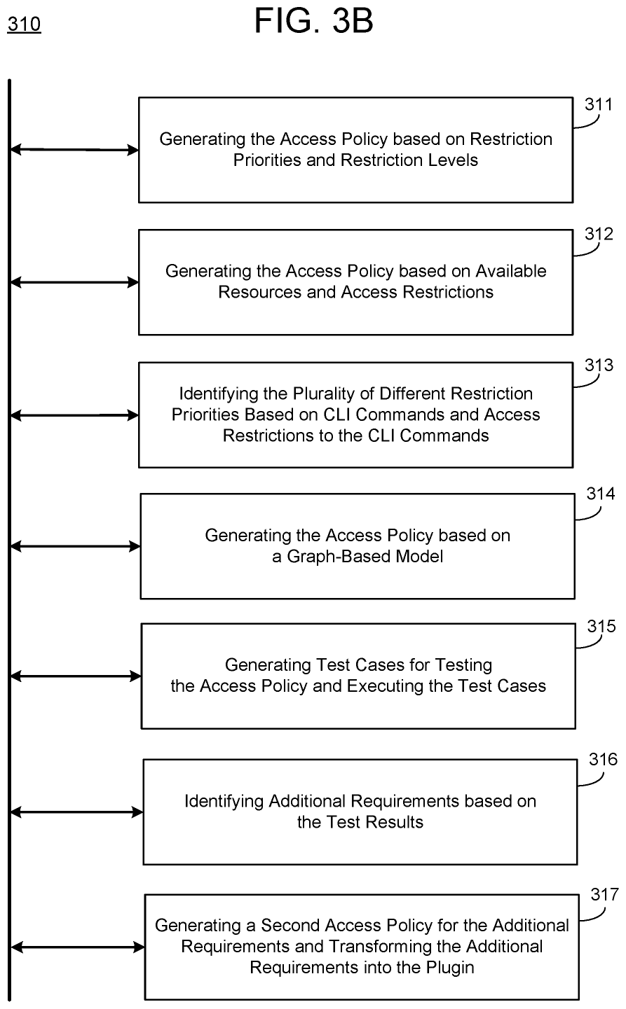

FIG. 3A illustrates a method 300 of generating an access policy for an authorization plugin according to example embodiments, and FIG. 3B illustrates a method 310 of generating an access policy for an authorization plugin according to other example embodiments. Referring to FIG. 3A, in 301, the method may include storing access requirements of a containerized environment. In 302, the method may include identifying a plurality of types of users of the containerized environment based on the access requirements. In 303, the method may include identifying a plurality of different restriction priorities for the plurality of types of users within the containerized environment, respectively, based on the access requirements. In 304, the method may include dynamically generating an access policy that satisfies the plurality of different restriction priorities for the plurality of types of users within the containerized environment, and in 305, transforming the access policy into a plugin.

Referring now to FIG. 3B, in 311, the dynamically generating may include generating the policy based on a restriction priority that identifies a priority among restriction sets of the containerized environment and a restriction level which identifies access rights of the plurality of users to a restricted object. In 312, the dynamically generating may include generating the policy based on available resources within the containerized environment and access restrictions on the available resources. In 313, the identifying the plurality of different restriction priorities may include identifying the plurality of different restriction priorities based on a list of command line interface commands available within the containerized environment and access restrictions to the list of command line interface commands. In 314, the dynamically generating may include generating the policy based on a graph-based model of the policy.

In 315, the method may further include generating test cases for testing the policy and running the test cases via a command line interface of the containerized environment to generate test results. In 316, the method may further include identifying custom requirements of the containerized environment from the generated test results. In 317, the method may further include generating a second policy for maintaining the custom requirements within the containerized environment and transforming the second policy into the plugin.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

Although an exemplary embodiment of at least one of a system, method, and computer readable medium has been illustrated in the accompanying drawings and described in the foregoing detailed description, it will be understood that the application is not limited to the embodiments disclosed but is capable of numerous rearrangements, modifications, and substitutions as set forth and defined by the following claims. For example, the system's capabilities of the various figures can be performed by one or more of the modules or components described herein or in a distributed architecture and may include a transmitter, receiver, or pair of both. For example, all or part of the functionality performed by the individual modules may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via a plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone, or any other suitable computing device, or combination of devices.

Presenting the above-described functions as being performed by a “system” is not intended to limit the scope of the present application in any way but is intended to provide one example of many embodiments. Indeed, methods, systems, and apparatuses disclosed herein may be implemented in localized and distributed forms consistent with computing technology.

It should be noted that some of the system features described in this specification have been presented as modules in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order and/or with hardware elements in configurations that are different from those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only, and the scope of the application is to be defined solely by the appended claims when considered with a full range of equivalents and modifications (e.g., protocols, hardware devices, software platforms, etc.) thereto.

What is claimed is:

1. An apparatus comprising:
a storage configured to store access requirements of a containerized environment; and
a processor configured to
identify a plurality of types of users of the containerized environment based on the access requirements,
identify a plurality of different restriction priorities for the plurality of types of users within the containerized environment, respectively, based on the access requirements,
dynamically generate an access policy that satisfies the plurality of different restriction priorities for the plurality of types of users within the containerized environment, and
transform the access policy into a plugin.

2. The apparatus of claim 1, wherein the processor is configured to generate the access policy based on a restriction priority that identifies a priority among restriction sets of the containerized environment and a restriction level which identifies access rights of the plurality of users to a restricted object.

3. The apparatus of claim 1, wherein the processor is configured to generate the access policy based on available resources within the containerized environment and access restrictions on the available resources.

4. The apparatus of claim 1, wherein the processor is configured to identify the plurality of different restriction priorities based on a list of command line interface commands available within the containerized environment and access restrictions to the list of command line interface commands.

5. The apparatus of claim 1, wherein the processor is configured to generate the access policy based on a graph-based model of the access policy.

6. The apparatus of claim 1, wherein the processor is further configured to generate test cases for testing the access policy and run the test cases via a command line interface of the containerized environment to generate test results.

7. The apparatus of claim 6, wherein the processor is further configured to identify additional requirements of the containerized environment from the generated test results.

8. The apparatus of claim 7, wherein the processor is further configured to generate a second policy for maintaining the additional requirements within the containerized environment and transform the second access policy into the plugin.

9. A method comprising:
storing access requirements of a containerized environment;
identifying a plurality of types of users of the containerized environment based on the access requirements;
identifying a plurality of different restriction priorities for the plurality of types of users within the containerized environment, respectively, based on the access requirements;
dynamically generating an access policy that satisfies the plurality of different restriction priorities for the plurality of types of users within the containerized environment; and
transforming the access policy into a plugin.

10. The method of claim 9, wherein the dynamically generating comprises generating the access policy based on a restriction priority that identifies a priority among restriction sets of the containerized environment and a restriction level which identifies access rights of the plurality of users to a restricted object.

11. The method of claim 9, wherein the dynamically generating comprises generating the access policy based on available resources within the containerized environment and access restrictions on the available resources.

12. The method of claim 9, wherein the identifying the plurality of different restriction priorities comprises identifying the plurality of different restriction priorities based on a list of command line interface commands available within the containerized environment and access restrictions to the list of command line interface commands.

13. The method of claim 9, wherein the dynamically generating comprises generating the access policy based on a graph-based model of the access policy.

14. The method of claim 9, wherein the method further comprises generating test cases for testing the access policy and running the test cases via a command line interface of the containerized environment to generate test results.

15. The method of claim 14, wherein the method further comprises identifying additional requirements of the containerized environment from the generated test results.

16. The method of claim 15, wherein the method further comprises generating a second access policy for satisfying the additional requirements within the containerized environment and transforming the second access policy into the plugin.

17. A computer-readable storage medium comprising instructions, that when read by a processor, cause the processor to perform a method comprising:
storing access requirements of a containerized environment;
identifying a plurality of types of users of the containerized environment based on the access requirements;
identifying a plurality of different restriction priorities for the plurality of types of users within the containerized environment, respectively, based on the access requirements;
dynamically generating an access policy that satisfies the plurality of different restriction priorities for the plurality of types of users within the containerized environment; and
transforming the access policy into a plugin.

18. The computer-readable storage medium of claim 17, wherein the dynamically generating comprises generating the access policy based on a restriction priority that identifies a priority among restriction sets of the containerized environment and a restriction level which identifies access rights of the plurality of users to a restricted object.

19. The computer-readable storage medium of claim 17, wherein the dynamically generating comprises generating the access policy based on available resources within the containerized environment and access restrictions on the available resources.

20. The computer-readable storage medium of claim 17, wherein the identifying the plurality of different restriction priorities comprises identifying the plurality of different restriction priorities based on a list of command line interface commands available within the containerized environment and access restrictions to the list of command line interface commands.
